(19) United States
(12) Patent Application Publication
(10) Pub. No.: US 2005/0097736 A1
(43) Pub. Date: May 12, 2005

(54) Method and system for integrated circuit bonding

(75) Inventor: Melvin Bringas Alviar, Baguio City (PH)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/706,389

(22) Filed: Nov. 10, 2003

(51) Int. Cl. C09J 5/00

(52) U.S. Cl. 29/831; 156/322

(57) ABSTRACT

According to one embodiment of the invention, a method for adhering an integrated circuit to a substrate includes receiving a boat configured to hold a plurality of substrates at a first position. The substrates include a first surface configured to support an integrated circuit. The boat of substrates is heated at the first position. The boat of substrates is transferred from the first position to a second position. The integrated circuit is positioned on the first surface of a selected one of the plurality of substrates at the second position. The integrated circuit includes an adhesive surface operable to adhere the integrated circuit to the selected substrate.

### TECHNICAL FIELD OF THE INVENTION

This invention relates generally to the field of integrated circuit packaging and, more specifically, to an improved method and system for bonding integrated circuits to a substrate.

### BACKGROUND OF THE INVENTION

The packaging of integrated circuits may include bonding integrated circuits and their associated components to a substrate that may include interconnect structures disposed on flexible film. To promote adherence of the integrated circuits to the substrates, the outer surfaces of the integrated circuits may be coated with an adhesive film or other material. The substrate may be heated as the integrated circuit is being affixed to the substrate to melt the film and promote the adherence of the integrated circuit to the substrate. The elevated temperature of the substrate, however, may cause inconsistencies to develop on the surface of the substrate. For example, the substrate may warp such that voids may develop between the surface of the integrated circuit and the surface of the substrate. Such defects may affect the quality and functionality of the integrated circuit.

### SUMMARY OF THE INVENTION

According to one embodiment of the invention, a method for adhering an integrated circuit to a substrate includes receiving a boat configured to hold a plurality of substrates at a first position. The substrates include a first surface configured to support an integrated circuit. The boat of substrates is heated at the first position. The boat of substrates is transferred from the first position to a second position. The integrated circuit is positioned on the first surface of a selected substrate at the second position. The integrated circuit includes an adhesive surface operable to adhere the integrated circuit to the selected substrate.

Some embodiments of the invention provide numerous technical advantages. Other embodiments may realize some, none, or all of these advantages. For example, an advantage may be that surface inconsistencies in the substrate may be reduced. For example, warping of the substrate may be eliminated such that the integrated circuit may more readily bond to the surface of the substrate. Another advantage may be that the development of voids and other bond line inconsistencies may be reduced. Accordingly, problems associated with delamination, coplanarity, and cratering may be reduced, and the quality and functionality of the integrated circuit may be improved.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 illustrates an example boat for transporting substrates in accordance with an embodiment of the invention;

FIG. 2 illustrates an example substrate in accordance with an embodiment of the invention;

FIG. 3 illustrates an example system for bonding integrated circuits to substrates in accordance with an embodiment of the invention; and

FIG. 4 illustrates an example bonded package in accordance with an embodiment of the invention.

### DETAILED DESCRIPTION OF EXAMPLE EMBODIMENTS OF THE INVENTION

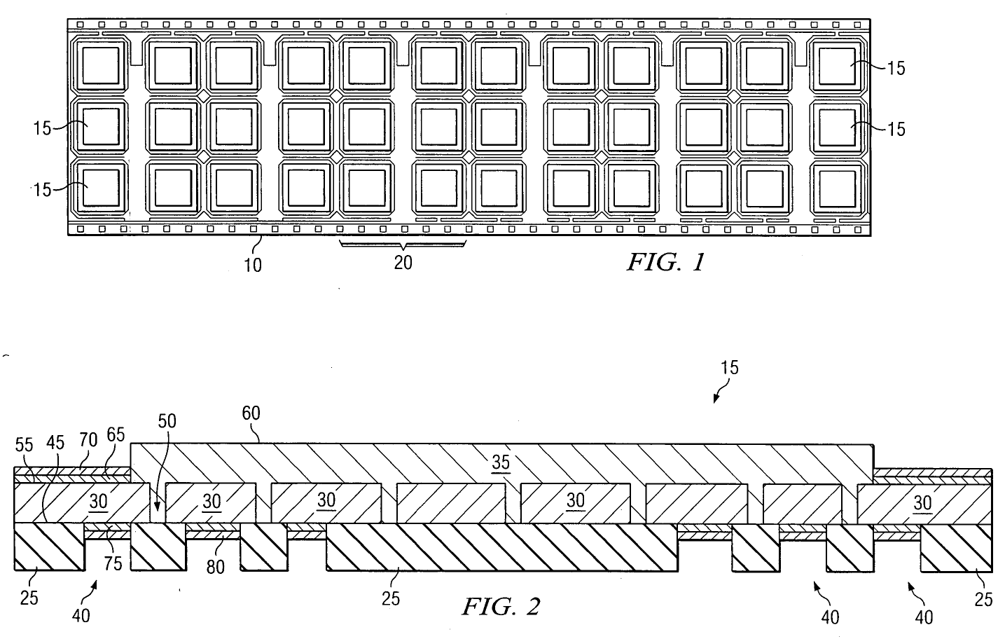

Example embodiments of the present invention and their advantages are best understood by referring now to FIGS. 1 through 4 of the drawings, in which like reference numerals refer to like parts.

Prior to packaging, integrated circuit devices such as transistors, processors, memories, logic units, and the like may be bonded on substrates using a die bonding apparatus. Many substrates may be loaded at one time into the die bonding apparatus in a boat. To effect the bonding of an integrated circuit to a substrate in the boat, the boat is first transferred to a dispense position in the die bonding. According to one embodiment of the present invention, at the dispense position, one or more substrates in the boat may be placed on or supported by a vacuum chuck. The vacuum chuck at the dispense position may include a heating element that acts to pre-heat the substrate to a desired temperature. The boat of pre-heated substrates may then be transferred to a bonding position. In the bonding position, the pre-heated substrates may be placed on or supported by a second vacuum chuck. The vacuum chuck at the bonding position may also be heated such that the elevated temperature of the pre-heated substrates are substantially maintained. At the bonding position, integrated circuits are adhered to the surfaces of the heated substrates. Because the substrates are pre-heated at the dispense position and the temperature is maintained at the bonding position, fewer surface inconsistencies and other defects may result from the bonding process.

FIG. 1 illustrates an example boat 10 configured to store substrates 15. The substrates 15 may be stored in boat 10 prior to being cycled through the die bonding apparatus. Boat 10 may also be used to store substrates 15 as the substrates 15 undergo other fabrication processes. As illustrated, boat 10 may be configured to hold one or more matrices 20 of substrates 15. In particular embodiments, boat 10 may be configured to hold six matrices 20 of substrates 15. Each matrix 20 of substrates 15 may include an array of substrates 15. For example, each matrix 20 of substrates 15 may include an array of six substrates 15. Accordingly, in particular embodiments, boat 10 may be configured to hold thirty-six substrates 15. The described configuration of boat 10, however, is merely exemplary. Boat 10 may be configured to hold any suitable number of substrates 15 appropriate for the bonding process. Boat 10 may be configured to store substrates 15 horizontally. In such a case, each substrate 15 may lie flat on the surface of boat 10. A clip may hold substrates 15 in place on boat 10.

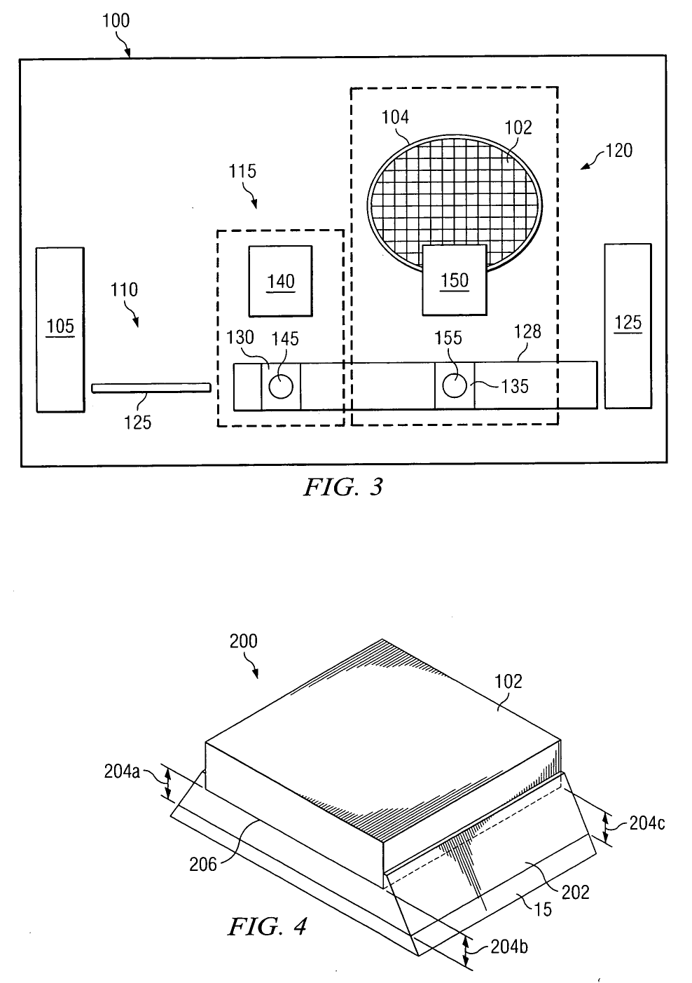

FIG. 2 illustrates an example substrate 15 for bonding. The bonding of an integrated circuit to substrate 15 will be described in more detail with regard to FIGS. 3 and 4. As illustrated, substrate 15 may include multiple layers formed adjacent to one another. For example, in the illustrated embodiment, substrate 15 includes a first layer 25, a second layer 30, and a third layer 35. The multiple layers may result in substrate 15 having a thickness on the order of approximately 67 to 145 microns. The particular thickness of substrate 15 and the materials used to form substrate 15 may depend on the respective thickness of each of the varying layers of substrate 15 and the type of integrated circuit to be bonded to substrate 15.

First layer 25 may be comprised of a tape, film, or other supportive material on which subsequent layers may be formed. First layer 25 may comprise a polyimide film or tape or other suitable polymer material. First layer 25 may be of any appropriate thickness for supporting integrated circuit 20 and any intervening layers formed on first layer 25. In particular embodiments, first layer 25 may be of a thickness on the order of 45 to 55 microns. For example, first layer 25 may comprise a polyimide tape of a thickness on the order of 50 microns. In other embodiments, first layer 25 may be of a thickness on the order of 67 to 83 microns. For example, first layer 25 may comprise a polyimide tape of a thickness on the order of 75 microns. As illustrated, first layer 25 may be configured such that the tape or film comprising first layer 25 includes one or more vias 40 formed through first layer 25. Vias 40 may be formed in first layer 25 using conventional photolithographic and etching processes. Vias 40 may operate to expose portions of second layer 30 formed on the inner surface 45 of first layer 25.

Second layer 30 is formed proximate to first layer 25 on inner surface 45 of first layer 25. Second layer 30 may comprise copper, aluminum, gold, nickel, paladium, or other conductive metal. Second layer 30 may function to conduct current between an integrated circuit bonded on substrate 15 and other semiconductor components. Second layer 30 may be of any appropriate thickness for providing current to a bonded integrated circuit. In particular embodiments, where second layer 30 is formed on first layer 25 of a thickness on the order of 50 microns, second layer 30 may be of a thickness on the order of 13 to 23 microns. For example, second layer 30 may be of a thickness on the order of 18 microns. In other embodiments, where second layer 30 is formed on first layer 25 of a thickness on the order of 75 microns, second layer 30 may be of a thickness on the order of 20 to 30 microns. For example, second layer 30 may be of a thickness on the order of 25 microns. The described dimensions, however, are for exemplary purposes only. The present invention contemplates that second layer 25 may be of any appropriate thickness for conducting current between a bonded integrated circuit and other semiconductor components.

In particular embodiments, second layer 30 may include one or more vias 50 formed through the second layer 30. Vias 50 may be formed in second layer 30 through conventional photolithographic and etching processes. Vias 50 may form a trench through a portion of second layer 30 to expose a portion of inner surface 45 of first layer 25. Vias 50 may be subsequently filled with material used to form third layer 35 or other conductive materials. Accordingly, vias 50 may form an interconnection between first layer 25 and subsequently formed third layer 35. After an integrated circuit is bonded to substrate 15 and the resulting combination is packaged, the conductive materials comprising second layer 30 and third layer 35 may operate as contacts for other semiconductor components. Accordingly, when second layer 30 is in contact with other semiconductor components, second layer 30 may transfer current from the semiconductor components to the bonded integrated circuit or vice versa.

As illustrated, substrate 15 also includes third layer 35 positioned adjacent to second layer 30. Third layer 35 may comprise a solder mask that includes an insulator that may act as a stress reliever and shock absorber of the packaged integrated circuit. In particular embodiments, third layer 35 may comprise CCR240CS as manufactured by Shindo or Shinko of Japan. Third layer 35 may be of any appropriate thickness for insulating the components of the integrated circuit and substrate 15. In particular embodiments, third layer 35 may be of a thickness on the order of 5 to 15 microns. For example, third layer 35 may comprise a solder mask of a thickness on the order of 10 microns. Third layer 35 may also act to support the integrated circuit on an outer surface 55 of third layer 35. As such, third layer 35 may be configured to support the integrated circuit on the outer surface of third layer 35. For example, third layer 35 may include one or more contacts configured such that the integrated circuit may be positioned on the one or more contacts. In particular embodiments, third layer 35 may include four contacts configured such that the four corners of the integrated circuit may align with the four contacts when the integrated circuit is correctly positioned on the substrate 15.

The exposed surfaces of second layer 30 may be plated with one or more conductive materials. The conductive materials plated on the exposed surfaces of second layer 30 may operate to insulate or protect the exposed surfaces of second layer 30. In various embodiments, the conductive materials plated on the exposed surfaces of second layer 30 may include nickel, gold, silver, aluminum, or other suitable conductive materials. In particular embodiments, two conductive materials may be plated sequentially on the exposed surfaces of second layer 30. Accordingly, a first conductive material may form a first outer plated layer 65 proximate to outer surface 55 of second layer 30. A second conductive material may form a second outer plated layer 70 proximate to first outer plated layer 65. The portions of second layer 30 that are exposed in vias 40 may be similarly plated with conductive materials. Accordingly, in particular embodiments, the first conductive material may form a first inner plated layer 75 proximate to an inner surface 45 of second layer 30. The second conductive material may form a second inner plated layer 80 proximate to first inner plated layer 75. Although FIG. 2 is illustrated with two layers of plating on the exposed portions of second layer 30, the present invention contemplates that any appropriate number of layers of plating may be formed on the exposed surfaces of second layer 30. Alternatively, some or all of the exposed portions of second layer 30 may not be plated with a conductive material allowing the outer surface 55 and inner surface 45 of second layer 30 to remain exposed.

In operation, substrates 15 may be prepared for the bonding process prior to entering a die bonding apparatus, which will be described in detail below with regard to FIG. 4. In preparation for the die bonding apparatus, first, second, and third layers 25, 30, and 35 of substrates 15 may be formed as described above. Formed substrates 15 may then be placed in boat 10 where they are stored until boat 10 is transferred to the die bonding apparatus. Multiple boats 10 may be stored in a magazine in preparation for loading into the die bonding apparatus. Also in preparation for the bonding process, a fabricated or partially fabricated wafer may be prepared and cut to form one or more integrated circuits from the cut wafer. The cut integrated circuits may include transistors, processors, memories, logic units, or other electrical devices. In particular embodiments, an adhesive layer may be dispensed on or applied to a surface of the wafer prior to being loaded in the die bonding apparatus. Alternatively, an adhesive layer may be dispensed on or applied to substrates 15 while being cycled through the die bonding apparatus. After preparation of substrates 15 and the wafer of cut integrated circuits, the components may then be transferred to the die bonding apparatus for the bonding process.

Substrates 15 in boat 10 may be heated during the bonding process to promote adherence of an integrated circuit to substrate 15. Specifically, the heating of substrate 15 allows any adhesive layers formed on the wafer of cut integrated circuits to melt such that adherence of the integrated circuit to a substrate 15 is improved. In particular embodiments, the adhesive layer formed on the integrated circuit may melt at a temperature on the order of 125 to 160° C. Accordingly, one or more substrates 15 in boat 10 may be heated to a temperature on the order of 125 to 160° C. as an integrated circuit is positioned on the outer surface 60 of the substrate. The abrupt heating of substrate 15 from room temperature, however, may cause substrate 15 to enter a state of thermal shock. Thermal shock alters various physical qualities of substrate 15. For example, substrate 15, which is typically substantially flat prior to being heated may become wavy, flimsy, or unstable. According to particular embodiments of the present invention, however, substrate 15 may be pre-heated by the die bonding apparatus to elevate the temperature of substrate 15 prior to the bonding process. The pre-heating of substrate 15 may substantially prevent the effects of thermal shock.

FIG. 3 illustrates an example bonding apparatus 100 for bonding integrated circuits 102 to substrates 15 in accordance with an embodiment of the invention. Bonding apparatus 100 includes a loading system 105, a feeding system 110, a dispense system 115, a bonding system 120, and an unloading system 125. A magazine storing multiple boats 10, which each store multiple substrates 15, is received in bonding apparatus 100 via loading system 105. A single boat 10 may then be removed from the magazine in the loading system and placed on feeding system 110, which then transports boat 10 of substrates 15 through die bonding apparatus 100 where various processes are performed on substrates 15.

Feeding system 110 includes an input rail 125, an indexer 128, and/or any other conveyor mechanisms for transporting boat 10 within bonding apparatus 100. Input rail 125 and indexer 128 may operate to transfer boat 10 between one or more components of bonding apparatus 100. For example, boat 10 may be placed on input rail 125 of feeding system 110 after substrates 15 are prepared for the bonding process. Input rail 125 may then transfer boat 10 to indexer 128. Indexer 128 may transport boat 10 to a dispense position 130 associated with dispense system 115 and to a bonding position 135 associated with bonding system 120. After the bonding process is complete, indexer 128 or another component of feeding system 110 may transport boat 10 of bonded integrated circuits- substrates to unloading system 125 where boat 10 may be placed in a magazine and/or removed from bonding apparatus 100.

The particular processes performed on substrates 15 while substrates 15 are at dispense position 130 and bonding position 135 may depend on the type of adhesive used to bond integrated circuit 102 to substrate 15. For example, adhesive may be applied directly to a wafer 104 of integrated circuits 102 before wafer 104 is loaded in bonding apparatus 100. The adhesive may comprise a film adhesive that is laminated on the surface of wafer 104. In particular embodiments, adhesive layer 22 may include a film adhesive such as NEX 130C made by Nippon Steel and Chemical Corporation (NSCC). Where, integrated circuits 102 include an adhesive layer, substrates 15 may be heated in bonding system 120 to promote the adherence of integrated circuits 102 on substrates 15. Specifically, the heating of substrates 15 in bonding position 135 may operate to melt the adhesive laminated on the surface of integrated circuits 102 as integrated circuits 102 are positioned on the outer surfaces 60 of substrates 15. Because the heating of substrates 15 at bonding position 135 may create inconsistencies in surfaces 60 of substrates 15, however, substrates 15 may be pre-heated by dispense system 115. The pre-heating of substrates 15 while at dispense position 130 may prevent the development of inconsistencies in the surfaces of substrates 15 during the subsequent bonding of the integrated circuits 102 to substrates 15.

In alternative embodiments, bonding apparatus 100 may be used to apply adhesive directly to the surface of substrates 15 before integrated circuits 102 are positioned on substrates 15. For example, adhesive may be applied to substrates 15 while substrates 15 are at dispense position 130. Although the adhesive layer may include any material for adhering integrated circuits 102 to substrate 15, an example of such a material may include an epoxy such as Ablestik Ablebond 84-3MV or 84-3MVBTI. Because the adhesive layer is applied directly on substrates 15 by bonding apparatus 100, it may not be necessary for substrates 15 to be pre-heated at dispense position 130 or heated at bonding position 135. Rather, die bonding apparatus 100 may merely deposit the adhesive on substrates 15 at dispense position 130 and position integrated circuits on substrates 15 at bonding position 135. Accordingly, the processes used by die bonding apparatus 100 at dispense position 130 and bonding position 135 varies depending on the type of adhesive used to bond integrated circuits 102 to substrates 15.

Dispense system 115 includes dispense position 130 and a dispense controller 140. Dispense system 115 operates to receive boat 10 via indexer 128. Dispense position 130 may include a chuck 145 or other supportive structure that may be mechanically or robotically operated to move horizontally and vertically beneath substrates 15 in boat 10. For example, chuck 145 may be mechanically or robotically operated to position chuck 145 under matrix 20 or another grouping of substrates 15 in boat 10. A vacuum or other force may be applied to matrix 20 of substrates 15 through chuck 145 to hold substrates 15 at dispense position 130 on chuck 145. In particular embodiments, the vacuum force may hold matrix 20 of substrates 15 in place as an epoxy or other adhesive material is dispensed on the surface of substrates 15. The application of epoxy or other adhesive may be controlled by dispense controller 140. Dispense controller 140 may operate to control the amount of epoxy or other adhesive that is applied to the surface of each substrate 15 to prepare the substrates 15 for the bonding of integrated circuits 102 to substrates 15.

Additionally or alternatively, the vacuum force may hold matrix 20 of substrates 15 in place as substrates 15 are pre-heated to a predetermined temperature. Accordingly, dispense position 130 may include a heating element that operates to heat chuck 145 at dispense position 130. The heating element may include a heating coil, controller, and any other appropriate components for heating chuck 145 to a desired temperature. As a result, substrates 15 or matrix 20 of substrates 15 positioned on chuck 145 may be pre-heated to the desired temperature. In particular embodiments, substrates 15 may be pre-heated to a temperature on the order of 125 to 160° C. For example, substrates 15 may be pre-heated to a temperature on the order of 135° C. As described above, the pre-heating of substrate 15 prior to the bonding process may prevent warping and other inconsistencies in outer surface 60 of substrates 15 during the subsequent bonding process.

Bonding system 120 includes bonding position 135, wafer 104, and a transfer assembly 150. Bonding system 115 receives boat 10 of substrates 15 from dispense system 110 via indexer 128. Indexer 128 may transfer boat 10 of substrates 15 from dispense position 130 to bonding position 135. Bonding position 135 may include a chuck 155 or other supportive structure that may be mechanically or robotically operated to move horizontally and vertically beneath substrates 15 in boat 10. For example, chuck 155 may be mechanically or robotically operated to position chuck 155 under matrix 20 or another grouping of substrates 15 in boat 10. A vacuum or other force may be applied to matrix 20 of substrates 15 through chuck 155 to hold substrates 15 at bonding position 135 on chuck 155. In particular embodiments, the vacuum force may hold matrix 20 of substrates 15 in place as bonding system 115 selects an integrated circuit 102 from wafer 104 and positions the selected integrated circuit 102 on a particular substrate 15 in boat 10.

As described above, integrated circuit 102 may include, in particular embodiments, an adhesive layer of film or other material that operates to affix the selected integrated circuit 102 to surface 60 of substrate 15. Where integrated circuits 102 include such an adhesive layer, bonding position 135 may include a heating element that operates to heat chuck 155 or other structure supporting substrates 15. The heating element may include a heating coil, controller, and any other appropriate components for heating chuck 155 to a desired temperature. The vacuum force applied through chuck 155 may hold matrix 20 of substrates 15 in place as heat is applied to substrates 15 through chuck 155. Heat may be applied to substrates 15 to maintain the temperature of substrates 15 at a desired temperature. In particular embodiments, substrates 15 may be heated to a temperature on the order of 125 to 160° C. The desired temperature may be substantially the same as the pre-heated temperature of substrates 15 at dispense position 130. For example, where substrates 15 are pre-heated to a temperature on the order of 135° C. at dispense position 130, the temperature of substrates 15 may be maintained at a temperature on the order of 130 to 135° C. As described above, the heating of substrates 15 at bonding position 135 may encourage the adherence of integrated circuit 20 to substrate 15. Specifically, the heating of substrates 15 at bonding position 130 may cause an adhesive layer formed on integrated circuits 102 to melt such that integrated circuits 102 more readily bond to substrates 15 when integrated circuits 102 are placed on substrates 15.

Transfer assembly 150 is a controllable electromechanical device that may be operated or programmed to selectively pick-up a particular integrated circuit 102 from wafer 104. Transfer assembly 150 may includes a transfer arm, controller, pickhead, any other components appropriate for the selection and transfer of integrated circuit 102 from wafer 104 to substrates 15 at bonding position 135. For example, a transfer controller may operate to move a transfer arm vertically and horizontally to control the placement of the transfer arm over wafer 104. Additionally, the transfer controller may allow for the rotational and angular motion of the transfer arm such that the transfer arm may be positioned over a particular integrated circuit 102 on wafer 104. Transfer assembly 150 may then pick-up a selected integrated circuit 102 using a suction force to adhere the selected integrated circuit 102 to a pickhead on the end of the transfer arm. The selected integrated circuit 102 may then be transferred from wafer 104 to other components within bonding apparatus 100. Specifically, the selected integrated circuit 102 may be transferred to bonding position 135 where the selected integrated circuit 102 is then positioned on outer surface 60 of a selected substrate 15 held at bonding position 135.

In operation, boat 10 is received at bonding apparatus 100 through feeding system 105. Feeding system 105 then transfers boat 10 to dispense position 130 of dispense system 115. As described above, the particular processes performed on substrates 15 at dispense position 130 may depend on the type of adhesive used by bonding apparatus 100 to adhere integrated circuits 102 to substrates 15. In particular embodiments, integrated circuits 102 include an adhesive layer such as a film or other material laminated on the surface of integrated circuits 102. Where integrated circuits 102 include such an adhesive layer, boat 10 containing substrates 15 may be pre-heated to a desired temperature while at dispense position 130. For example, a vacuum chuck 145 may be robotically and mechanically maneuvered such that chuck 145 is placed beneath a matrix 20 or other grouping of substrates 15. A vacuum force may hold matrix 20 of substrates 15 in dispense position 135 as matrix 20 of substrates 15 is pre-heated to the desired temperature. After matrix 20 of substrates 15 reaches the desired temperature, chuck 145 may be moved vertically such that matrix 20 of substrates 15 are released from the vacuum force holding matrix 20 of substrates 15 on chuck 145. Chuck 145 may then be moved horizontally until chuck 145 is beneath a second matrix 20 of substrates 15. Chuck 145 may be moved vertically until chuck 145 is proximate to the second matrix 20 of substrates 15. Chuck 145 may then be used to pre-heat the second matrix 20 of substrates 15 to the desired temperature. In this manner, chuck 145 may be mechanically maneuvered to pre-heat all substrates 15 held in boat 10. Alternatively, chuck 145 may not be moved horizontally. Rather, indexer 128 may be mechanically controlled to move boat 10 in increments through dispense position 135, such that matrices 20 of substrates 15 may be sequentially pre-heated to the desired temperature. Pre-heating substrates 15 at dispense position 130 may prevent the development of inconsistencies in outer surface 50 of substrates 15 during the subsequent bonding process.

After boat 10 of substrates 15 is pre-heated to the desired temperature, feeding system 110 transports boat 10 of substrates 15 to bonding position 135. In particular embodiments, matrix 20 or another grouping of substrates 15 may be held in bonding position 135 by chuck 155. For example, a vacuum force may be applied to substrates 15 to hold substrates 15 at bonding position 135. An integrated circuit 102 may then be selected and lifted from wafer 104 by transfer assembly 150. The selected integrated circuit 102 may be transferred to bonding position 135 where the selected integrated circuit 102 is bonded to outer surface 60 of a particular substrate 15 held in place by chuck 155. Where integrated circuit 102 includes an adhesive layer or film on the surface of integrated circuit 102, a heating element at bonding position 135 may substantially maintain the pre-heated temperature of substrates 15. For example, chuck 155 may include a heating element such that chuck 155 may be mechanically operated similar to chuck 145 to heat substrates 15 to the desired temperature. As described above, the heating of substrates 15 at bonding position 135 promotes the adherence of integrated circuit 102 to substrate 15 when integrated circuit 102 is positioned on substrate 15. Following the bonding of integrated circuit 102 to substrate 15, feeding system 110 transfers the bonded combination to unloading system 125 where boat 10 may removed from bonding apparatus 100 or placed in a magazine for removal from bonding apparatus 100.

FIG. 4 illustrates an example bonded package 200 after the bonding of integrated circuit 102 to substrate 15. In the illustrated example, bonded package 200 includes integrated circuit 102 bonded on substrate 15 by an adhesive layer 202. As described above, adhesive layer 202 may include an epoxy distributed on outer surface 60 of substrate 15 prior to the bonding process. Alternatively, adhesive layer 202 may include a film or other adhesive material laminated on the surface of integrated circuit 102 prior to the bonding process. As described above with regard to FIG. 3, where adhesive layer 202 includes a film or other adhesive material laminated on the surface of integrated circuit 102, substrate 15 may be heated during various stages of the bonding process. For example, substrate 15 may be pre-heated to a desired temperature at dispense position 130. The pre-heating of substrate 15 at dispense position 130 prevents substrate 15 from entering a state of thermal shock during the subsequent bonding of integrated circuit 102 to substrate 15. Thermal shock may alter various physical qualities of an affected substrate. For example, an affected substrate, which is typically substantially flat prior to being heated, may become wavy, flimsy, or unstable. Because a substrate in thermal shock may develop voids between the substrate and the adhesive layer when the integrated circuit is bonded to the substrate, inconsistencies in the surface of a substrate may result in poor adherence of an integrated circuit to the substrate. Specifically, air may become trapped between the substrate and the integrated circuit. Air voids may result in the delamination of the integrated circuit from the substrate and other defects affecting the quality and functionality of the integrated circuit and the substrate. Because the pre-heating of substrate 15 prevents thermal shock and reduces the occurrence of voids between adhesive layer 202 and substrate 15, the adherence of integrated circuit 102 to substrate 15 may be improved. Additionally, substrate 15 may be heated as integrated circuit 102 is bonded to substrate 15 to further promote the adherence of integrated circuit 102 to substrate 15.

To determine the presence of inconsistencies in surface 60 of substrate 15 that may result from thermal shock, various measurements of bonded package 200 may be taken. The various measurements may be used to determine the amount of warpage exhibited by substrate 15 after the bonding process. For example, a bond line thickness 204 may be measured at various points in bonded package 200. Bond line thickness 204 is the measurement of distance between outer surface 60 of substrate 15 and the inner surface 206 of integrated circuit 102. In particular embodiments, bond line thickness 204 may be measured at each of the four corners of bonded package 200 resulting in four bond line thickness measurements 204a, 204b, 204c, and 204d. Bond line thickness measurements 204a, 204b, 204c, and 204d may be taken using a microscope focused at the die area. For example, a z-scaler may be used to determine bond line thickness measurements 204. The z-scaler may be focused at each corner of integrated circuit 102 to determine the thickness of integrated circuit 102 at each corner. The z-scaler may then be reset and focused on outer surface 60 of substrate 15 at the point where each bond line thickness measurement 204 is desired. The bond line thickness 204 at each point is the difference between the two measurements. From the calculated bond line thickness measurements 204 for bonded package 200, a tilt measurement may be calculated by subtracting the minimum bond line thickness measurement 204a, 204b, 204c, or 204d from the maximum bond line thickness measurement 204a, 204b, 204c, or 204d. Additionally, bond line thickness measurements 204a, 204b, 204c, and 204d may be compared with a target bond line thickness. The bond line thickness measurements 204 and the tilt measurement are helpful in estimating the amount of warping or other surface inconsistencies resulting from heating substrate 15.

Other tests may also be performed to determine the quality of the bond between integrated circuit 102 and substrate 15. For example, an adhesion test may be performed randomly on bonded packages 200 after bonded packages 200 are removed from bonding apparatus 100 and adhesive layer 202 is allowed to cure. An adhesion test may include a peel off test. Accordingly, integrated circuit 102 may be mechanically peeled from the surface of substrate 15. The surfaces of the resulting peeled layers may be physically examined using a microscope or the naked eye to determine the presence of any air voids between substrate 15 and adhesive layer 202. Other tests may also be performed to determine whether transfer assembly 150 of bonding apparatus 100 is positioning integrated circuit 102 at the proper place on substrate 15. These and other tests may be used in addition to the taking of bond line thickness measurements 204 or in lieu of the taking of the bond line thickness measurements 204.

Although embodiments of the invention and their advantages are described in detail, a person skilled in the art could make various alterations, additions, and omissions without departing from the spirit and scope of the present invention, as defined by the appended claims.

1. A method for adhering an integrated circuit to a substrate comprising:
receiving a boat configured to hold a plurality of substrates at a first position, the substrates having a first surface configured to support an integrated circuit;
heating the boat of substrates at the first position;
transferring the boat of substrates from the first position to a second position;
positioning the integrated circuit on the first surface of a selected one of the plurality of substrates at the second position, the integrated circuit comprising an adhesive surface operable to adhere the integrated circuit to the selected substrate.

2. The method of claim 1, wherein the adhesive surface is selected so as to melt at a predetermined temperature.

3. The method of claim 1, wherein the substrate comprises:
a first layer of film comprising an outer film surface;
a second layer comprising a conductive material, the second layer positioned adjacent to the outer film surface of the first layer; and
a third layer comprising a solder mask positioned adjacent to the second layer, the third layer selected so as to not melt at the predetermined temperature, an outer surface of the third layer configured to support the integrated circuit.

4. The method of claim 3, wherein the first layer has a thickness of 45 to 55 microns.

5. The method of claim 3, wherein the first layer has a thickness of 67 to 83 microns.

6. The method of claim 1, wherein heating the boat of substrates at the first position comprises positioning a portion of the substrates in the boat proximate a heating element such that warping of the substrates is prevented.

7. The method of claim 1, wherein heating the boat of substrates at the first position comprises heating the boat of substrates to a temperature of 125 to 160° C.

8. The method of claim 1, further comprising holding the selected substrate in the second position using a vacuum chuck.

9. The method of claim 1, further comprising maintaining the temperature of the selected substrate at a temperature of 125 to 160° C. at a the second position.

10. The method of claim 1, further comprising receiving the boat of substrates at a feeding system, the feeding system operable to transport the boat to the first position.

11. The method of claim 1, further comprising calculating a plurality of bond line thickness measurements after the integrated circuit is positioned on the first surface of the selected substrate.

12. The method of claim 1, further comprising performing an adherence test to determine if voids are present between the first surface of the substrate and the integrated circuit.

13. An apparatus for adhering an integrated circuit to a substrate, comprising:
a first position operable to:
receive a boat configured to hold a plurality of substrates, the substrates having a first surface adapted to support an integrated circuit; and
heat the boat of substrates;
a second position operable to receive the plurality of substrates from the first position; and
a first transfer assembly operable to position the integrated circuit on the first surface of a selected one of the plurality of substrates, the integrated circuit comprising an adhesive surface operable to adhere the integrated circuit to the selected substrate.

14. The apparatus of claim 13, wherein the adhesive surface is selected so as to melt at a predetermined temperature.

15. The apparatus of claim 13, wherein the substrate comprises:
a first layer of film comprising an outer film surface;
a second layer comprising a conductive material, the second layer positioned adjacent to the outer film surface of the first layer; and
a third layer comprising a solder mask positioned adjacent to the second layer, the third layer selected so as to not melt at the predetermined temperature, an outer surface of the third layer configured to support the integrated circuit.

16. The apparatus of claim 15, wherein the first layer has a thickness of 45 to 55 microns.

17. The apparatus of claim 15, wherein the first layer has a thickness of 67 to 83 microns.

18. The apparatus of claim 13, wherein the first position comprises a heating element proximate the boat, the heating element operable to heat a portion of the substrates in the boat such that warping of the substrates is prevented.

19. The apparatus of claim 13, wherein the first position is operable to heat the boat of substrates to a temperature of 125 to 160° C.

20. The apparatus of claim 13, wherein the second position is further operable to hold the selected substrate by applying a vacuum force to the selected substrate through a chuck.

21. The apparatus of claim 13, wherein the second position is further operable to maintain the temperature of the selected substrate at 125 to 160° C.

22. The apparatus of claim 13, further comprising a feeding system operable to:
receive the boat of substrates; and
transport the boat of substrates to the first position.
